(19) United States
(12) Patent Application Publication
(10) Pub. No.: US 2008/0192608 A1
(43) Pub. Date: Aug. 14, 2008

(54) Velocity Control of Holographic Media

(75) Inventors: Allen K. Bates, Tucson, AZ (US); Daniel J. Winarski, Tucson, AZ (US)

Correspondence Address: INGRASSIA FISHER & LORENZ, P.C. (IBM), 7010 E. COCHISE ROAD, SCOTTSDALE, AZ, 85253, US

(73) Assignee: INTERNATIONAL BUSINESS MACHINES CORPORATION, Armonk, NY (US)

(21) Appl. No.: 11/674,782

(22) Filed: Feb. 14, 2007

(51) Int. Cl. G11B 7/00

(52) U.S. Cl. 369/103

(57) ABSTRACT

A holographic storage device for reading media includes a first, holographic layer and a second, stamped layer having a plurality of land and grooved tracks. A sled is adapted to move radially across the media to allow access to the first and second layers. A first laser device is mounted on the sled for performing input/output (I/O) functions on the first layer of the media. A second laser device is mounted on the sled for reading the plurality of land and grooved tracks. The plurality of land and grooved tracks is adapted to sinusoidally oscillate radially on the media at a first wavelength to allow velocity control of the media, and sinusoidally oscillate radially on the media at a second, shorter wavelength to identify a landmark on the plurality of the land and grooved tracks.

### BACKGROUND OF THE INVENTION

1. Field of the Invention

The present invention relates in general to computers, and more particularly to a holographic storage device and associated media.

2. Description of the Prior Art

An alternative approach to traditional surface-based storage systems like compact discs (CDs) or digital versatile discs (DVDs) is volumetric storage technology, in which the full volume of a storage medium is used to increase data capacity. Holographic storage is one type of volumetric storage technology. Holographic storage has the potential to provide relatively high data density and short access times as compared to conventional optical or magnetic-tape storage technologies.

In conventional volume holographic storage, or page-based holographic storage, laser light from two beams, a reference beam and a signal beam containing encoded data, overlap within the volume of a photosensitive holographic medium. The interference pattern resulting from the overlap of the two beams creates a change or modulation of the refractive index of the holographic recording medium. Multiple bits are encoded and decoded together in pages, or multi-dimensional arrays of bits. Multiple pages can be stored within the volume by angular, wavelength, phase-code, or related multiplexing techniques. Each page can be independently retrieved using its corresponding reference beam. The reference beam interacts with the stored refractive index modulation and reconstructs the signal beam containing the encoded data. The parallel nature of this storage approach allows high transfer rates and short access times.

In bit-wise volume holography, data are stored bitwise in a photosensitive volume as microscopic reflection gratings called micro-holograms. A single micro-hologram corresponds to a single bit, where the presence or absence of a micro-hologram corresponds to a “1” or a “0” (or vice-versa). Overlapping micro-holograms can be stored in the same volume element by using multiplexing techniques, such as angle multiplexing or wavelength multiplexing. Such storage of multiple bits in the same volume element of the disk increases the storage capacity and potentially also the data transfer rates by the multiplex factor.

There is a constant requirement to find ways to increase the data storage density of holographic media. It is therefore desirable to find holographic systems and methods of using such systems, which help increase the data storage density.

### SUMMARY OF THE INVENTION

In addition to the continuing requirement to increase data storage density, a need exists for holographic media which supports holographic media velocity control using wobbly tracks in an underlying DVD layer in a holographic data storage drive. This underlying DVD layer may be a DVD-RAM, DVD-RW, or DVD-R layer.

Accordingly, in one embodiment, the present invention is a holographic storage device for reading media having a first, holographic layer and a second, stamped layer having a plurality of land and grooved tracks, the storage device comprising a sled adapted to move radially across the media to allow access to the first and second layers, a first laser device mounted on the sled for performing input/output (IO) functions on the first layer of the media, and a second laser device mounted on the sled for reading the plurality of land and grooved tracks, wherein the plurality of land and grooved tracks is adapted to sinusoidally oscillate radially on the media at a first wavelength to allow velocity control of the media, and sinusoidally oscillate radially on the media at a second, shorter wavelength to identify a landmark on the plurality of the land and grooved tracks.

In another embodiment, the present invention is a holographic storage media, comprising a first, holographic layer, and a second, stamped layer associated with the first, holographic layer, the second, stamped layer having a plurality of land and grooved tracks, wherein the plurality of land and grooved tracks is adapted to sinusoidally oscillate radially at a first wavelength to allow for velocity control of the media, and sinusoidally oscillate radially at a second, shorter wavelength to identify a landmark on the plurality of the land and grooved tracks.

In still another embodiment, the present invention is a method of manufacturing a holographic storage device for reading media having a first, holographic layer and a second, stamped layer having a plurality of land and grooved tracks, the storage device comprising providing a sled adapted to move radially across the media to allow access to the first and second layers, providing a first laser device mounted on the sled for performing input/output (IO) functions on the first layer of the media, and providing a second laser device mounted on the sled for reading the plurality of land and grooved tracks, wherein the plurality of land and grooved tracks is adapted to sinusoidally oscillate radially on the media at a first wavelength to allow velocity control of the media, and sinusoidally oscillate radially on the media at a second, shorter wavelength to identify a landmark on the plurality of the land and grooved tracks.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates two holographic optical paths, including a first optical path for holography and a second optical path for DVD;

FIG. 2 illustrates oscillating tracks for a constant angular velocity (CAV) holographic disk;

FIG. 3 illustrates oscillating tracks for a constant linear velocity (CLV) holographic disk;

FIG. 4 illustrates velocity-control oscillations versus landmark-identification oscillations; and

FIG. 5 illustrates a servo device having three outputs including tracking error signal (TES), velocity control, and landmark identification components.

### DETAILED DESCRIPTION OF THE DRAWINGS

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In one embodiment, the present invention is directed towards a dual-layer, reflective, holographic-DVD disk, where the underlying DVD-RAM layer has spiral tracks stamped into the media at the time of manufacture, tracks which physically oscillate radially, in a sinusoidal manner, and at a low, but detectable, amplitude. This sinusoidal oscillation is (a) of a constant physical period throughout the disk for a Constant Linear Velocity (CLV) disk or (b) of a period which varies directly with radius for a Constant Angular Velocity (CAV) disk. The drive servos on these oscillating tracks, thus the drive can count the number of oscillations per unit time, and thus simultaneously control the IO velocity of both the holographic layer and the adjacent DVD-RAM layer by use of the tracking error servo (TES). So-called “landmarks”, such as new track and new sector demarcations are identified by changing the wavelength of the sinusoidal oscillation.

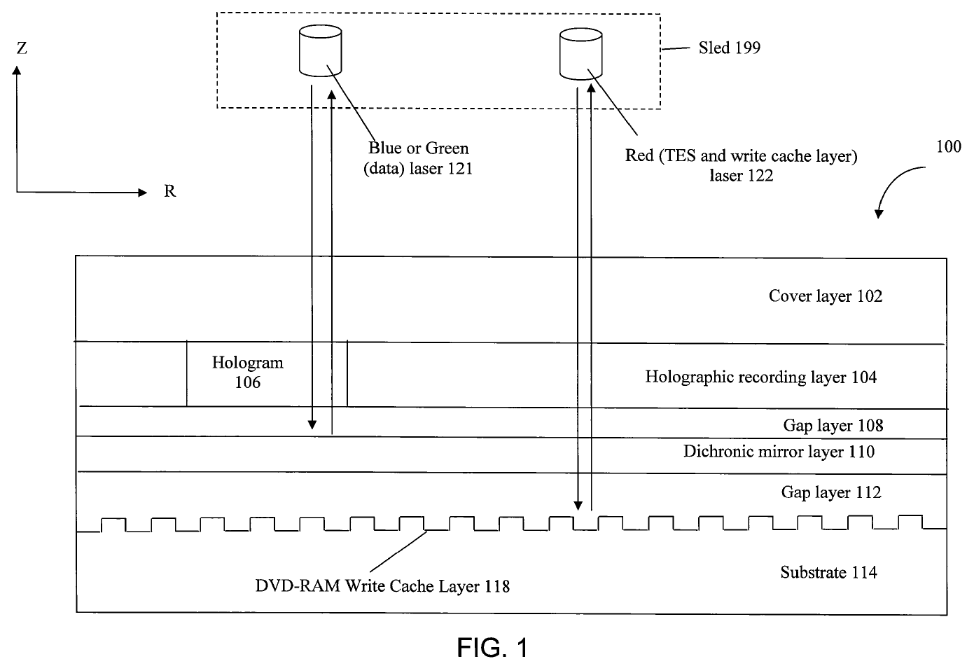

FIG. 1 shows a cross-section of reflective holographic media 100 comprising transparent cover layer 102, holographic recording layer 104, gap layer 108, dichronic mirror layer 110, gap layer 112, substrate 114, and DVD-RAM (rewritable) layer 118 which is stamped into a first surface of substrate 114 to provide lands and grooves and then coated with a phase-change media to make the layer recordable. DVD-RAM layer 118 could alternately be a DVD-RW (read-write), or a DVD-R (recordable) layer, or merely a stamped layer which provides tracking capability but has no recording capability. Hologram 106 is written and read by light from first laser 121, which makes first laser 121 a data laser. Light from first laser 121, which may be either blue (405 nm) or green (514 or 532 nm) in wavelength, is selectively reflected by dichronic mirror layer 110, and thus does not penetrate to DVD-RAM layer 118 of holographic media 100. Holographic recording layer 104 is the principal, high-capacity, long-term data storage layer.

Dichronic mirror layer 110 is selectively transparent to the wavelength of light from second laser 122, in this case red laser light of a wavelength of 680 nm, which is the same wavelength of the common DVD (Digital Versatile Disk). Light from second laser 122 and first laser 121 do not have the same wavelength. However, second laser 122 and first laser 121 are on the same physical sled 199 for radial seeks along the disk 100.

Light from second laser 122 selectively passes through dichronic mirror layer 110 and can read-from or write-to DVD-RAM layer 118 of holographic disk 100, as well as track along the lands and grooves of this stamped layer 118. The cross-section of disk 100 in FIG. 1 shows this stamped layer 118 to have a cross-section which looks like a square-wave, and the lands are the top of the square wave, and the grooves are the downward indentations of this square-wave. DVD-RAM layer 118 of holographic media 100 is rewritable, and thus may be used as a write-cache of data destined for eventual storage in the holographic recording layer. Thus, DVD-RAM layer 118 is a temporary, lower-capacity, short-term data storage layer. DVD-RAM layer 118 is reflective, so that light from second laser 122 is reflected back to the holographic disk drive. The lands and grooves of stamped DVD-RAM layer 118 of holographic media 100 aid the servo of the holographic drive in tracking during the writing and reading of hologram 106 in holographic recording layer 104, which makes second laser 122 a radial tracking-error-servo (TES) laser in addition to a write-cache laser.

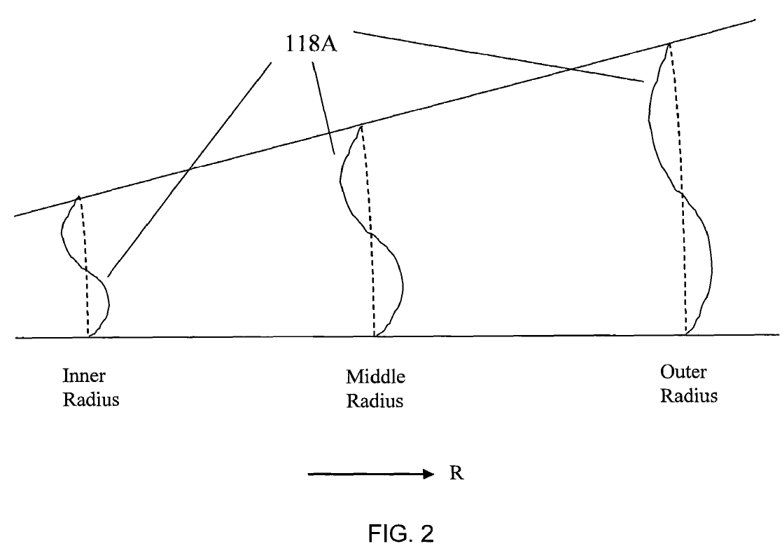

Consider a first example A involving a constant angular velocity (CAV) disk embodiment. By CAV, disk 100 is spun at a constant RPM in the IO drive. If the disk 100 is a CAV holographic disk, the physical period of tracks 118A in FIG. 2 vary directly as to the radius of that groove from the center of rotation of disk 100. The velocity servo of the drive modulates the spin rate of disk 100 to a constant angular velocity, by counting the number of oscillations sinusoidal oscillations in the track over a fixed period of time. This causes disk 100 to spin at the same angular velocity regardless of where the optical head is performing I/O.

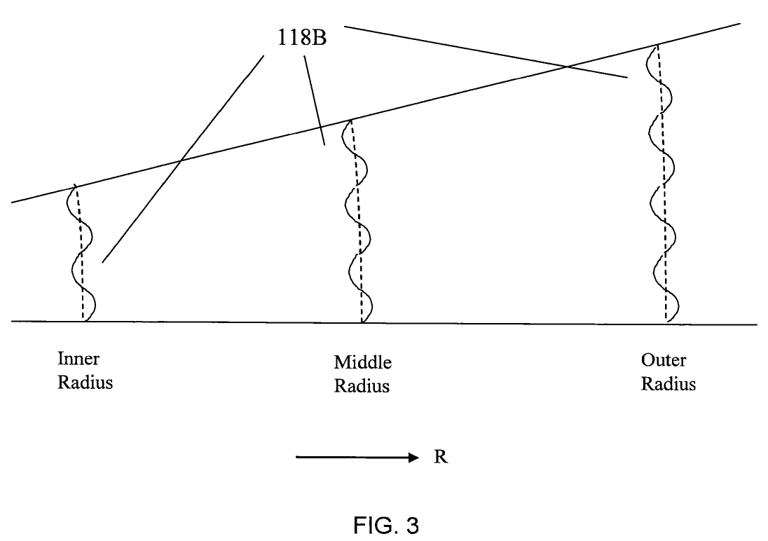

In addition to example A, consider a second example B involving a constant linear velocity (CLV) disk embodiment. If the disk 100 is a CLV holographic disk, the physical period of tracks 118B in FIG. 3 are constant across disk 100. The velocity servo of the drive modulates the spin rate of disk 100 to a constant linear velocity, by counting the number of oscillations sinusoidal oscillations in the track over a fixed period of time. This causes disk 100 to slow down in angular velocity as the optical head seeks from an inner to an outer radius.

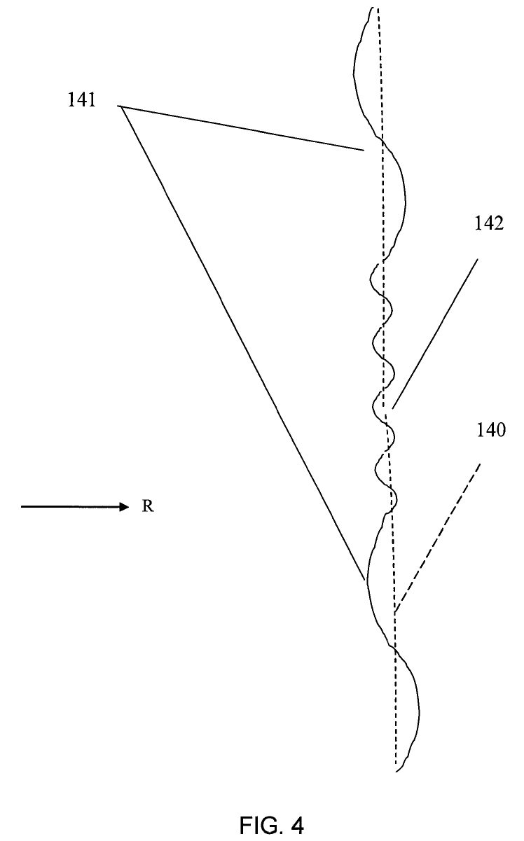

If a landmark is needed on the disk, such as the beginning of a new track or a new data sector, the wavelength of the landmark sinusoidal oscillation 142 is dramatically and temporally increased over the velocity control sinusoidal oscillation 141, in order to denote that landmark, as shown in FIG. 4. Such landmarks 142 may be used to denote track IDs or sector IDs to aid in the reading and writing of holograms 106. An integral number of wavelengths are in landmark sinusoidal oscillation 142 and the total length of landmark sinusoidal oscillation 142 is that of velocity control sinusoidal oscillation 141, so that the velocity control remains synchronized with itself. The nominal track direction is shown as dashed line 140, for reference purposes only.

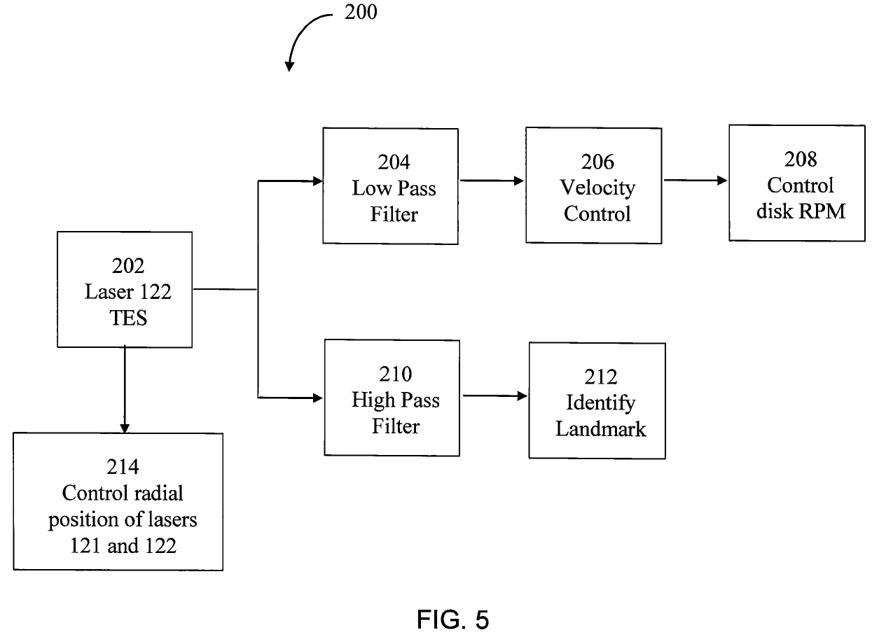

In FIG. 5, the output of the track error servo (TES) module 202 of laser 122 is used for the radial positioning 214 of the IO head comprising second laser 122 and particularly first laser 121, as both of these lasers are on the same radially moving sled 199. Additionally, the output of TES module 202 is split into two more components. A low pass filter module 204 is used to isolate velocity control sinusoidal oscillations 141 for use by velocity control module 206 to control the RPM 208 of disk 100. In parallel, a high pass filter module 210 is used to isolate and thus identify 212 landmark sinusoidal oscillations 142. Such low and high pass filter devices can be constructed and operated using tools and components known in the art.

In general, software and/or hardware to implement various embodiments of the present invention, or other functions previously described, such as the described velocity control function, can be created using tools currently known in the art.

While one or more embodiments of the present invention have been illustrated in detail, the skilled artisan will appreciate that modifications and adaptations to those embodiments may be made without departing from the scope of the present invention as set forth in the following claims.

What is claimed is:

1. A holographic storage device for reading media having a first, holographic layer and a second, stamped layer having a plurality of land and grooved tracks, the storage device comprising:
a sled adapted to move radially across the media to allow access to the first and second layers;
a first laser device mounted on the sled for performing input/output (I/O) functions on the first layer of the media; and
a second laser device mounted on the sled for reading the plurality of land and grooved tracks, wherein the plurality of land and grooved tracks is adapted to sinusoidally oscillate radially on the media at a first wavelength to allow velocity control of the media, and sinusoidally oscillate radially on the media at a second, shorter wavelength to identify a landmark on the plurality of the land and grooved tracks.

2. The holographic storage device of claim 1, wherein the second, shorter wavelength is of a length that is an integer divisor of the first wavelength.

3. The holographic storage device of claim 1, wherein the second, shorter wavelength is detected via a high-pass filter in a tracking error servo of the storage device, and the first wavelength is detected via a low-pass filter in the tracking error servo of the storage device.

4. The holographic storage device of claim 1, wherein the second laser controls the velocity of the media in a constant linear velocity mode.

5. The holographic storage device of claim 1, wherein the second laser controls the velocity of the media in a constant angular velocity mode.

6. The holographic storage device of claim 1, wherein the second layer of the media is selected from the group consisting of DVD-RAM, DVD-RW, and DVD-R formats.

7. A holographic storage media, comprising:
a first, holographic layer; and
a second, stamped layer associated with the first, holographic layer, the second, stamped layer having a plurality of land and grooved tracks, wherein the plurality of land and grooved tracks is adapted to sinusoidally oscillate radially at a first wavelength to allow for velocity control of the media, and sinusoidally oscillate radially at a second, shorter wavelength to identify a landmark on the plurality of the land and grooved tracks.

8. The storage media of claim 7, wherein the second, shorter wavelength is of a length that is an integer divisor of the first wavelength.

9. The storage media of claim 7, wherein the second, shorter wavelength is detected via a high-pass filter in a tracking error servo of a storage device, and the first wavelength is detected via a low-pass filter in the tracking error servo of the storage device.

10. The storage media of claim 9, wherein a first laser device associated with the storage device controls the velocity of the media in a constant linear velocity mode.

11. The storage media of claim 9, wherein a first laser device associated with the storage device controls the velocity of the media in a constant angular velocity mode.

12. The storage media of claim 7, wherein the second layer is selected from the group consisting of DVD-RAM, DVD-RW, and DVD-R formats.

13. A method of manufacturing a holographic storage device for reading media having a first, holographic layer and a second, stamped layer having a plurality of land and grooved tracks, the storage device comprising:
providing a sled adapted to move radially across the media to allow access to the first and second layers;
providing a first laser device mounted on the sled for performing input/output (I/O) functions on the first layer of the media; and
providing a second laser device mounted on the sled for reading the plurality of land and grooved tracks, wherein the plurality of land and grooved tracks is adapted to sinusoidally oscillate radially on the media at a first wavelength to allow velocity control of the media, and sinusoidally oscillate radially on the media at a second, shorter wavelength to identify a landmark on the plurality of the land and grooved tracks.

14. The method of manufacture of claim 13, wherein the second, shorter wavelength is of a length that is an integer divisor of the first wavelength.

15. The method of manufacture of claim 13, wherein the second, shorter wavelength is detected via a high-pass filter in a tracking error servo of the storage device, and the first wavelength is detected via a low-pass filter in the tracking error servo of the storage device.

16. The method of manufacture of claim 13, wherein the second laser device controls the velocity of the media in a constant linear velocity mode.

17. The method of manufacture of claim 13, wherein the second laser device controls the velocity of the media in a constant angular velocity mode.

18. The method of manufacture of claim 13, wherein the second layer of the media is selected from the group consisting of DVD-RAM, DVD-RW, and DVD-R formats.
